(19) United States
(12) Patent Application Publication
(10) Pub. No.: US 2012/0058221 A1
(43) Pub. Date: Mar. 8, 2012

(54) MASHING METHOD FOR THE PRODUCTION OF KVASS WORT

(75) Inventor: Konrad Muller-Affermann, Freising (DE)

(73) Assignee: KRONES AG, Neutraubling (DE)

(21) Appl. No.: 13/266,852

(22) PCT Filed: Apr. 28, 2010
(86) PCT No.: PCT/EP2010/002610

§ 371 Date: Nov. 21, 2011

(30) Foreign Application Priority Data
May 8, 2009 (DE) 10 2009 020 386.9

(51) Int. Cl. C12C 7/04; C12C 7/20; C12C 7/165; C12C 5/02; C12C 7/053; C12C 7/16

(52) U.S. Cl. 426/16

(57) ABSTRACT

A mashing method for producing kvass wort and a method for producing kvass wort concentrate and kvass, where a first portion of mash, in particular a portion of rye mash, is mashed and is heated to a temperature lying below the boiling point (≦90°), a second portion of mash is mashed, and the mixed first and second portions of mash are heated in stages.

### CROSS-REFERENCE TO RELATED APPLICATION

The present application claims the benefit of priority of International Patent Application No. PCT/EP2010/002610, filed Apr. 28, 2010, which application claims priority of German Application No. DE102009020386.9, filed May 8, 2010. The entire text of the priority application is incorporated herein by reference in its entirety.

### FIELD OF THE DISCLOSURE

The disclosure relates to a mashing method for the production of kvass wort and a method of producing kvass.

### BACKGROUND

Kvass is a very old beverage which is traditionally made of bread, cereals, malts and sugar, and to which other vegetable substances are often added. Fermentation is in most cases effected with a mixed culture of yeasts and lactic acid bacteria, so that the soft drink containing carbon dioxide has an appreciable acid, while it only contains little alcohol. A constitutional effect has been attributed to kvass already for centuries, and in Russia, the Ukraine and other countries of Eastern Europe, it counts among the national drinks. In recent years, this traditional product experienced a boost mainly in Russia and the Ukraine.

Today, kvass is often produced in a 50-year-old plant and a technology which is equally old. In the classic production process, sometimes considerable problems occur as a result of the rye contents, as rye contains, for example, substances such as pentosans, which, when they are insufficiently decomposed or a lot of oxygen is introduced, can have a strong viscosity-increasing effect and thereby have negative effects on filtration/separation. The kvass rye malt moreover contains grain parts which aggravate solution and can hinder further processability.

Up to now, the kvass wort producers have accepted very longsome and energy consuming production processes, wherein mashing periods last up to 5 hours. A mashing method known from prior art is shown in FIG. 3. Here, two portions of mash are produced in parallel or subsequently. In a first, in most cases larger (raw grain) portion of mash, unmalted cereals (e.g. rye, barley, corn) are mashed together with water at low temperatures. Moreover, technical enzymes and/or small malt proportions (as enzyme donors) are added. Subsequently, the raw grain mash is heated in stages to the boiling point (ca. 100° C., preferably keeping certain stands at different temperatures), and the mixture is maintained at this temperature for several minutes.

In most cases, in parallel to this (staggered in time), the smaller second malt mash is mashed in a cold state, and its pH value is adjusted to about 5.0 to 5.5. Then, the two mashes are combined. This is done by scalding the boiling mash (raw grain mash) to the colder mash (malt mash). Since, however, the proportion of the 100° C. hot raw grain mash is in most cases too large, the complete amount cannot be added to the second portion of mash at once, as otherwise the temperature of the malt mash would excessively increase and thus important stands at certain temperatures would be skipped. These respective stands, however, are necessary as certain substances must be decomposed by the enzymes, and the individual groups of enzymes also have, apart from optimum pH values, optimum temperature values. So, if certain temperature levels are skipped, important enzymes can only function in a restricted way, or they can even be damaged, so that a conversion of certain classes of substances is prevented or aggravated. Therefore, only a portion of the hot raw grain mash is in each case scalded to the malt mash (in FIG. 3 represented in a dashed line) to thus cause temperature rise in stages. The final mash now has a concentration of e.g. 12 to 16° Plato.

As the raw grain mash can only be added to the colder malt mash in stages, two mashing devices, i.e. for example two mash tuns, are blocked for a long period, so that no high brew cycle is possible with only two vessels. In beverage production, however, 10 to 14 brews per day are desirable. A high brew cycle can thus only be realized by providing a great amount of equipment (e.g. mash or buffer tanks). Moreover, energy consumption is high in the known mash process. Furthermore, in this procedure, the process waste heat cannot be optimally utilized.

### SUMMARY OF THE DISCLOSURE

Starting from this situation an aspect of the present disclosure is to provide an energy-saving, improved mashing method for the production of kvass wort which can then be further processed to kvass wort concentrate or directly to kvass.

By the first portion of mash now being no longer heated to the boiling point (ca. 100° C.) in mashing according to the present disclosure, energy consumption can be reduced here. Moreover, the advantage here is that the hot first portion of mash does not have to be added to the second colder portion of mash in stages, but that the two portions of mash can rather be mixed at a time, because the mixing temperature then does not excessively rise, i.e. preferably not above 60° C. to 65° C. This means in practice that the then emptied mash vessel is available for the next brew more quickly. Thus, the brew number per day can be clearly increased by this method, or one can do without further (mash) vessels. The heating of the portion of mash (in step a) can be done in a first mashing device, and mashing (in step b) of the second portion of mash can be done in a second mashing device, wherein the portions of mash can then either be mixed in the first or in the second mashing device.

However, it is also possible that the second portion of mash is also mashed in the first mashing means, which also spares one mash vessel.

It is also possible that first cold water is added to the hot first portion of (rye) mash, and then the malt is mashed in.

Mashing can then be done directly in the mashing device, i.e. the mash tun, or else by means of a pre-masher.

The temperature to which the first portion of mash is heated in step a in particular lies within a range of 75° C. to 90° C., advantageously, however, within a range of 80° C. to 85° C. The temperature, however, should preferably be selected to be so hot that the gelatinization temperature of all raw materials, in particular the rye products, is reached and slightly exceeded. The temperature of the first portion of mash of 75° C. to 90° C., preferably 80° C. to 85° C., will then be sufficient to ensure saccharification of the rye starch and obtain the activity of the thermally stable amylase preparations. The amylase activity moreover saves costs for additional enzyme preparations in the further production process.

Advantageously, during the heating of the first portion of mash, one stand or several shorter stands are kept within a temperature range of 56° C. to 70° C. Thus, the crystalline starch molecules can be broken open more effectively, i.e. gelatinized (this is done with rye at temperatures between 56° C. and 70° C., depending on the type and year). Since often no sorted charges are available and the exact determination of the respective gelatinization temperature involves considerable costs, an efficient and raw material-specific mashing process can be realized by stands within this range according to the disclosure.

The mashing-in temperature of the first portion of mash is 30° C. to 65° C., preferably 35° C. to 55° C. This has several advantages. On the one hand, lump formation of the cereals, which are in most cases finely milled, is prevented; on the other hand, heat recovery can be more effective. Thus, the warm water, which is produced e.g. during boiling in the pan vapor condenser, and/or which arises in wort or concentrate cooling, can be used effectively. Moreover, a reasonable use of the warm last runnings (extract-containing flush water), which arise in filtration, is possible. The mashing-in temperature range according to the disclosure therefore permits economically effective heat recovery and lower energy consumption.

Advantageously, the first portion of mash is a portion of rye mash comprising water, technical enzymes and means for adjusting the pH-value, and containing rye or rye products, in particular rye flour and so-called “fermented” kvass rye malt as a raw material.

Since the first portion of mash as raw material mainly contains the complete rye proportion of the total mash (the proportion of rye in the first portion of mash is advantageously 90-100% of the total rye proportion of the total mash), by temperature control and pH value adjustment, one can especially cater to the rye products. Accordingly, the first portion of mash advantageously exclusively comprises rye or rye products as raw material, wherein a small portion of malt can be added as “enzyme donor”.

The second portion of mash comprises water, advantageously technical enzymes, means for adjusting the pH value, and barley and barley malt. However, as an alternative or in addition, the addition of wheat, corn, buckwheat, rice (which should be cooked beforehand) and/or potatoes or other cereals and/or products of these is also conceivable.

The first portion of mash is produced with a high proportion of raw materials, wherein the mashing-in ratio (main liquor to grist ratio) amount of raw materials (kg)/amount of water (l) is within a range of 1:2 to 1:3.4, in particular 1:2.5 to 1:3. Such a thick portion of mash involves a higher concentration of first wort, in particular within a range of 18 to more than 28° Plato. Since the wort is in many plants diluted or previously evaporated for fermentation, a higher extract concentration should be aimed at. By this, the corresponding brew vessels and fittings can be designed to be smaller, while the same performance is offered, resulting in a saving of investment costs. Moreover, energy costs for heating the mash can be cut. If the wort is evaporated, a higher starting concentration increases the efficiency of the evaporation plant as less water must be expelled. Correspondingly, the above mentioned mashing-in ratio is optimal for generating a high first wort concentration, and investment as well as operating costs can be cut thereby.

Since the first portion of rye mash preferably consists of 40-80%, the second portion of mash (residual mash) preferably contains 20-60% of the total raw materials employed.

The second portion of mash is also produced to be thick for the above reasons, with a mash liquor ratio of 1:2 to 1:3.4, in particular 1:2.5 to 1:3.

To reduce the temperature of the first portion of rye mash, the mashing-in temperature of the second portion of mash is, depending on the mashing-in method, advantageously 5° C. to 25° C., preferably 10° C. to 15° C. However, since there is a risk in that lumps could be formed at such low temperatures, the cold water, which is used for the second portion of mash, can also be combined first with the first portion of rye mash, so that a correspondingly cooler mixing temperature of 35° C. to 65° C. is adjusted. Subsequently, the remaining (cool) raw materials can be mashed into the now diluted, cooler rye mash without lumps.

By this process, a mash liquor ratio of the total mash of 1:2 to 1:3.4, in particular 1:2.5 to 1:3 should result. The total mash temperature should be below 65° C. at the beginning.

Advantageously, the mash is mechanically vibrated by means of a vibration system at least in step c, preferably, however, during the complete mashing-in and mashing process. Vibration has a positive effect on the enzymatic decomposition of starch and reduces gas adherence to the particles. By the vibration, the duration of mashing can be reduced. Moreover, filterability of the final kvass can be improved.

In a method of producing kvass, first raw materials are provided, in particular ground malt and crushed or milled raw materials (cereals). The raw materials mixed with water are subjected to a mashing process. To separate the still contained particles of the mash, separation is effected, e.g. by means of a lauter tun, a mash filter and/or a centrifuge. Heating is followed by fermentation of the kvass wort and optionally filtration of the produced kvass. Finally, additives, such as sugar and/or flavors and acids, colorants, stabilizers and preservatives, can be added.

According to a preferred embodiment, after lautering/filtering/separating, the kvass wort can be heated, where advantageously the hot break should be separated off afterwards.

The wort can also be evaporated before fermentation and thus concentrated. The produced concentrate can moreover be boiled to thus adjust the desired sensory properties. Instead, however, corresponding additives, such as flavors and colorants, can be added.

### BRIEF DESCRIPTION OF THE DRAWINGS

The present disclosure will be illustrated below in greater detail with reference to the following figures.

FIG. 1 shows, in a schematic representation, a flow chart of a kvass brewery for performing the method according to the disclosure,

FIG. 2 shows thermal behavior depending on time according to the inventive mashing method, and

FIG. 3 shows thermal behavior depending on time according to a mashing method according to prior art.

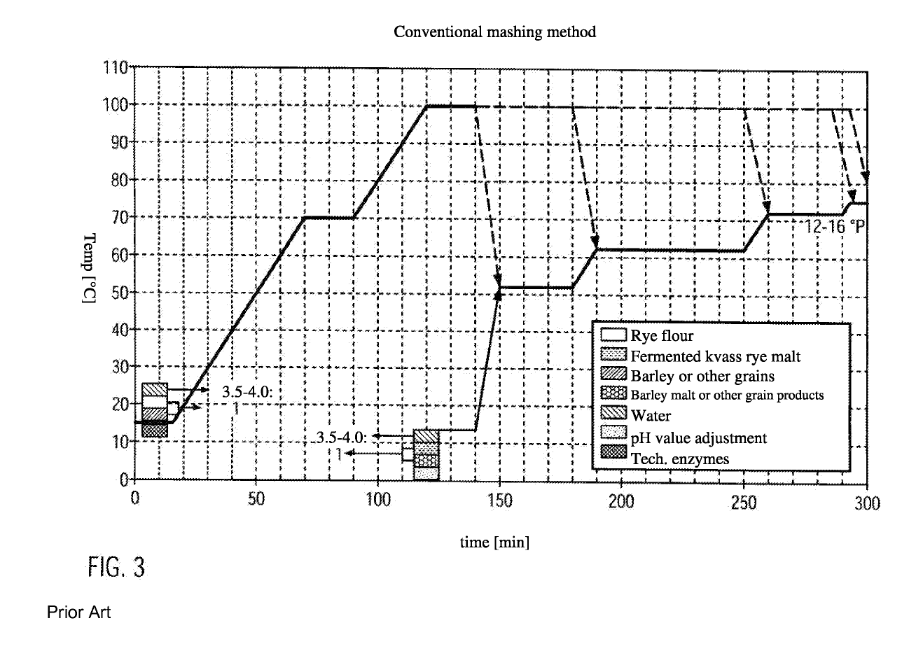

### DETAILED DESCRIPTION OF THE DRAWINGS

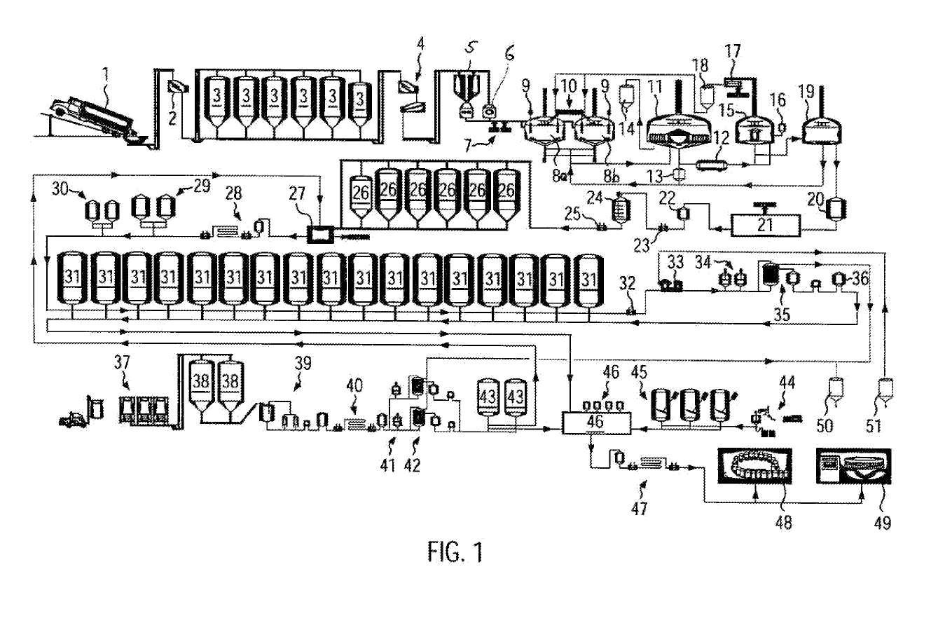

In connection with the flow chart of a kvass brewery shown in FIG. 1, the production process for kvass according to the disclosure will be illustrated more in detail.

First, raw materials, in particular milled malt and crushed cereals, are provided.

As raw materials, rye (e.g. in the form of rye and/or rye malt, and/or so-called “fermented” kvass rye malt, and/or (mixed) rye bread), barley (barley and/or barley malt and/or (mixed) barley bread), wheat (wheat and/or wheat malt and/or (mixed) wheat bread), corn (corn and/or (mixed) corn bread) are possible. Further possible raw materials are buckwheat and buckwheat products, rice and rice products, potatoes and potato products, as well as other cereals and/or sugar- and/or starch-containing ingredients.

As can be taken from the embodiment shown in FIG. 1, the supplied raw materials are emptied e.g. via an infeed 1 and transported to a pre-cleaning system 2 by means of a transport means. Subsequently, the goods freed from coarse impurities get into the silos 3 where they are stored. If required, the cereals are then withdrawn from the silos and subsequently cleaned by a plansifter and a stone separator 4. From there, they are transported to the corresponding milling systems. In the process, malts are wet milled in a roller mill 5[k1], whereas raw cereals are crushed by means of a (hammer) mill, in particular a hammer mill 6[k2]. For example, the pre-mashed goods can then be mixed in a (worm) conveyor with calcium chloride, acid or caustic solution, and/or with other agents that adjust the pH value via a corresponding apparatus 7, so that it reaches a pH value that is ideal for enzymatic decomposition.

According to a preferred embodiment, the actual mashing process takes place in two mash vessels 8a, b which can have similar designs and can also be used as mash kettles. The mash vessels are equipped with an agitator and heating devices in a well-known manner. In the mash vessels 8a, b, the raw materials are mashed with water as will be illustrated more in detail below. To ensure an improved, low-oxygen operating process, the mash vessels comprise vibrators 9 which mechanically vibrate the mash. In the process, the vibrators (for example at least one vibrator rod) reciprocate mechanically in the mash (e.g. at varying frequencies). Corresponding enzymes and agents for adjusting the pH value can be added to the mash. The enzyme is here added manually via the manhole 10.

Upon termination of the mashing process, i.e. when iodine normality is reached, the mash is lautered/filtered and, for example, pumped into the lauter tun 11 in the process. Lautering, however, can also be done by means of a mash filter, a centrifuge or any other device for separation. The clarified wort is collected in an underback 12. After sufficient lixiviation of the spent grain has been effected, the last runnings are collected in the last runnings container 13, and the spent grain is transported into the spent grain bunker 14.

According to a preferred embodiment, the wort can be forwarded to a boiling device 15 for wort boiling. The latter is embodied with a (hop) dosing tank 16, so that fruit or other additives can be added at this point of the process. The vapors formed during boiling are cooled down in a reverse flow by means of cold water, e.g. via a pan vapor condenser 17. The warm water produced in this way is collected in a warm water tank 18 and can be used e.g. for mashing the next brew. As soon as boiling is terminated, the wort is freed from the hot break, for example by means of a whirlpool and/or another device 19. From there, the wort is pumped into a buffer tank 20, so that a continuous supply into an evaporation plant 21 can be ensured. Since the possibly subsequent concentrate boiling is not continuous, the concentrate is collected in a collecting vessel 22. Then it is heated, in particular by means of plate or tubular heat exchangers 23, and introduced into a concentrate boiler 24. There, over-pressure boiling is effected with continuous agitation. Upon termination of the boiling, the hot concentrate is again cooled down via a heat exchanger, in particular a plate or tubular heat exchanger 25, and pumped into the concentrate storage tanks 26. If required, it can be filled for sale from there, or, as represented, further processed within the plant.

According to a further embodiment, the boiling of the kvass wort is effected with the apparatuses 15 to 18, and no hot break separation is done. After lautering, the wort can be supplied to a buffer tank and subsequently heated, and then optionally either evaporated (or first heated, then buffered, and then evaporated), to obtain the concentrate.

It is also possible to produce kvass directly, without evaporating the kvass wort. Then, the components 20 to 28 can be omitted.

In the production of kvass from kvass wort concentrate, the latter is diluted with water in a mixing device 27 and mixed with the corresponding quantity of syrup. If no concentrate was produced before, the wort can be either used without being mixed, or it can be also diluted with water to obtain a corresponding wort contents.

To avoid foreign contaminations in fermentation, the wort-syrup mixture can be pasteurized or flash pasteurized by means of a heating means 28. Subsequently, lactic acid bacteria from the assimilator 29, and yeasts from the assimilator 30 can be dosed into the wort flow.

Kvass should always be a fermented product. It is here up to the manufacturers whether they
apply mixed fermentation where the organisms are located together in the tank, or whether they
have the yeast and lactic acid fermented in separate containers, and then blend the two formed products (Here, even individual strains of organisms can be treated separately). Or whether they
either only perform fermentation with yeasts and subsequently add technical lactic acid, or fermentation with lactic acid is effected and the flavors from yeast fermentation are optionally added.

Fermentation is effected in fermentation tanks 31, here represented as combined fermentation and pressure tanks. After fermentation, the in most cases still warm product (fermentation is often effected at temperatures of 15-42° C., preferably 30-40° C.) is cooled down, preferably first in a heat exchanger 32 (preferably a plate or tube heat exchanger). Subsequently, the cooler kvass can be filtered. Here, a major portion of microorganisms as well as contained particles are preferably first separated off with a centrifuge 33. Subsequently, filtration is effected, advantageously precoat filtration. In the process, a compounded kieselguhr mixture is dosed into the product stream by a supply 34, and the product is filtered by means of the precoat filter, e.g. precoat tube filter 35. Subsequently, sterile filtration can optionally be effected.

The kvass is then directed into pressure tanks (in this case fermentation and pressure tanks) via a collecting vessel 36. To adjust the ratio (sugar-acid ratio) in the final drink, additional sugar is often required. The sugar should be ideally present in the form of a syrup, or produced as such. This is done, for example, by introducing the supplied crystal sugar into an automatic drain station 37. From there, it can be transported into the sugar silos 38, so that there will be sufficient infeed for the solution process. After the sugar has been continuously dissolved in the apparatus 39, the syrup is pasteurized/flash pasteurized by means of the pasteurizer/flash pasteurizer 40. Via the apparatus 41, activated carbon can be added, if required, and filtration can be carried out via 42. Then, the syrup is stored in the corresponding tanks 43. Other additives can be supplied in the form of powder and must then be mixed/dissolved to concentrates in the corresponding solution tanks 44 before they are introduced into the process. These concentrates are then stored in concentrate storage tanks 45. The same process is followed with syrups which are delivered in barrels. The kvass is then mixed in a mixer 46. In the process, the fermented kvass wort (now: kvass) can be mixed, for example, with the following additives: sugar (syrup), acids, kvass wort, colorants, stabilizers, flavors, concentrates, juices, nectars, and/or preservatives.

The end product is flash pasteurized by means of a heater 47 and forwarded to the fillers 48, 49, where it can be filled into many diverse packs.

For disposal, the used kieselguhr is directed into the tank 50 and the organisms are transferred into the autolysis tank 51.

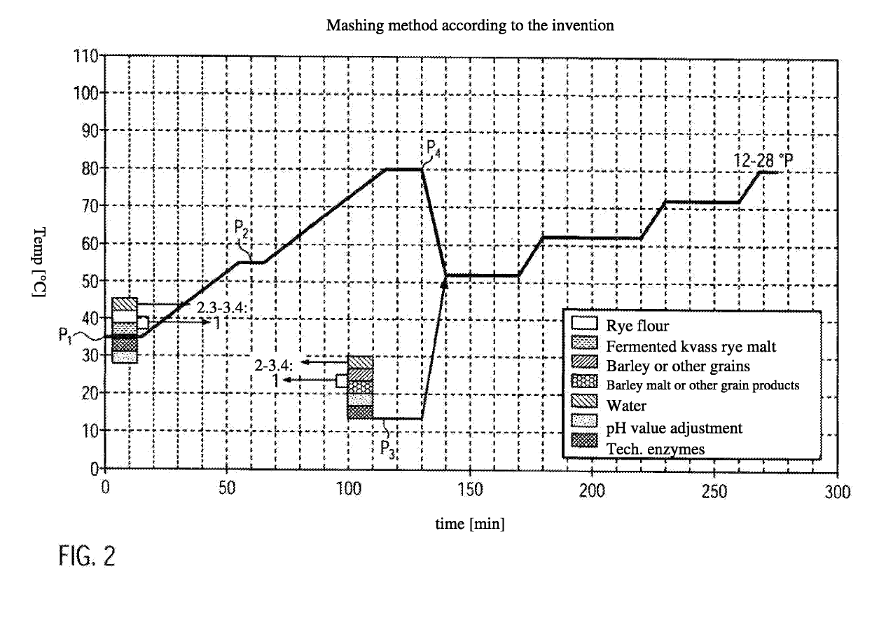

Below, the kvass-mashing method according to the disclosure will be illustrated more in detail in connection with FIG. 2 by way of example. First, a first portion of mash, in particular a portion of rye mash, can be mashed in the mashing section 7 or in a mash tun (e.g. 8a). Here, the portion of rye mash comprises, for example, rye flour, so-called “fermented” kvass rye malt and water.

Compared to prior art, mashing is effected here in a warm state within a range of 30 to 65° C., ideally 35 to 55° C. Here, the previously cold brew water is heated by waste heat from the process (P1).

Since fermented or roasted rye malt is very acidic, the pH value must be adjusted during mashing to e.g. 5.6 to 6.5 (optionally by adding caustic solution), so that the enzymes can act to their optimum. The addition of cytolytic, proteolytic and amylytic and pentosan decomposing enzymes and the addition of thermally stable amylases make sense for the portion of rye mash and should be correspondingly adapted depending on the recipe. However, other enzymes can also be employed.

Advantageously, the mashing ratio (mash liquor ratio) of amount of raw material (kg)/amount of water (l) is within a range of 1:2 to 1:3.4, in particular 1:2.5 to 1:3. The thicker mash permits a more economical mashing process as kvass worts having higher first wort concentrations of 18 to more than 28° Plato can be produced, and the amount of apparatuses can be reduced thereby, while performance remains the same, and current costs (e.g. for mash heating and the pump operation) and consequential costs (e.g. for evaporating the wort) can be cut. Since the wort is in many plants diluted or even previously evaporated for fermentation, this higher extract concentration should be aimed at. By this, the corresponding brew vessels and fittings can be designed to be smaller while they offer the same performance, resulting in a saving of investment costs. Moreover, energy costs for heating the mash can be saved. If the wort is evaporated, a higher starting concentration increases the efficiency of the evaporation plant as less water must be expelled. However, since a thicker mash aggravates enzymatic reactions and correspondingly more technical enzymes must be added, one has to determine the intersection between a reasonable mashing ratio and additional costs for enzyme preparations individually and depending on the recipe.

After mashing, the crystalline starch molecules must be broken open, i.e. gelatinized. This is done with rye at temperatures between 56 to 70° C. depending on the type and year. Since often no sorted charges are available and the exact determination of the respective gelatinization temperature involves considerable costs, it makes sense to use a generally applicable mash scheme. Correspondingly, in the represented example, a stand between 56 and 70° C. is kept (P2) (several shorter stands within the temperature range would also be possible). The total duration of the stand is about 10 to 40 minutes, preferably, however, 10 minutes. In the embodiment shown in FIG. 2, the stand is kept at about 54° C. for 10 minutes. The low temperature is to cause proteins and the like to be decomposed, so that the starch molecules are approachable in the saccharification stand. The heating rate is e.g. within a range of 0.5° C./min to 2.5° C. per minute. The portion of rye mash, i.e. the first mash, does not have to be boiled (at about 100° C.). A maximum heating temperature, or a temperature of the portion of mash of 70° C. to 90° C., in particular 75° C. to 85° C., is sufficient to saccharify the rye starch and obtain the activity of the thermally stable amylase preparations. The amylase activity moreover saves costs for additional enzyme preparations in the further production process. The first portion of mash is then maintained for about 5 to 40 minutes, in particular 10 minutes, at the elevated temperature of the portion of mash of 80° C. to 90° C., or 80° C. to 85° C., respectively. Therefore, the example illustrated in FIG. 2 represents a stand of 10 minutes at 80° C.

Since the industrially produced kvass should have the flavor of rye bread (and also due to the availability and the price), the rye (flour) proportion preferably amounts to 30 to 80% of the total employed raw materials. The so-called “fermented” kvass rye malt is additionally decisively responsible of the flavor and the coloring. Therefore, the proportion of fermented kvass rye malt advantageously amounts to 10 to 50% of the total employed raw materials. Thus, for the first portion of rye mash, a total raw material proportion of 40 to 80% advantageously results.

To also saccharify the other raw materials, such as barley malt and barley (but also the other raw materials mentioned above), these are also subjected to a mashing process (P3).

The second portion of mash is also produced to be thick for the above reasons, with a mash liquor ratio of 1:2 to 1:3.4, in particular 1:2.5 to 1:3.

To reduce the temperature of the first portion of rye mash, the mashing temperature of the second portion of mash is, depending on the mashing method, advantageously 5° C. to 25° C., preferably 10° C. to 15° C. However, since there is a risk in that lumps are formed at such low temperatures, it is also possible to first join the cold water, which is used for the second portion of mash, with the first portion of rye mash, so that a correspondingly cooler mixing temperature of 35° C. to 65° C. is adjusted. Subsequently, the remaining (cool) raw materials can be mashed into the now diluted, cooler rye mash without lumps.

This process should give a mash liquor ratio of the total mash of 1:2 to 1:3.4, in particular 1:2.5 to 1:3. The total mash temperature should be below 65° C. at the beginning.

The temperature of the total mash is then increased in stages until the total mash is iodine normal.

Since the portion of rye mash is not boiled (and is correspondingly colder than the traditionally produced raw grain cooker mash), the total amount of cold malt mash can be supplied without the temperature rising excessively (above 60 to 65° C., P4). For this, the plant represented by way of example offers various possibilities, including:
One possibility would be to mix the raw materials with cold water in the mashing section 7 (preferably also in a mash liquor ratio of 1:2.5 to 1:3). Subsequently, the mixture (second portion of mash) could be supplied to the first portion of rye mash (e.g. in the container 8a), so that the total mash correspondingly cools down (in the example to 54° C.).
As an alternative, one could also first only add the cold water of the second portion of mash to the first portion of rye mash (e.g. in 8a), so that there will be corresponding cooling and dilution of the portion of rye mash. Subsequently, the remaining raw materials could be introduced into the diluted, cooler rye mash.
Another possibility offers itself if in the other mash tun (e.g. 8b), the second portion of mash is prepared in a cold state staggered in time. Then, either the contents of the container 8a can be added to 8b, or vice-versa.

In practice, this means that preferably always one mash vessel is drained and is available for a further brew, so that by this method, the number of brews per day can be clearly increased, and/or a further mash vessel can be dispensed with.

To obtain the desired properties of the total mash (preferably: a mash liquor ratio of 1:2.5 to 1:3, a pH value of about 5.5 to 6.5, a temperature of below 65° C., and a required enzyme equipment of the total mash), further ingredients can be added which cause these properties (e.g. caustic solution, acid, enzymes, raw materials).

The mixing temperature of the two mashes is here about 53° C. Correspondingly, the temperature of the first and the second portion of mash can be increased or reduced if the amounts are adapted in advance.

The total mash is further heated, where in particular a protein stand at a temperature of 45° C. to 60° C. for a duration of 5 to 50 minutes, a maltose stand at 60° C. to 70° C. for a duration of 5 to 50 minutes, and a saccharification stand within a temperature range of 70° C. to 80° C. for a duration of 5 to 50 minutes are kept. Ideally, a first wort concentration of more than 18 to 28° Plato results.

During the complete mashing-in and mashing process, care is taken that the process is carried out with little oxygen and little air. The vibrator system is preferably employed during the complete mashing-in and mashing process. The mashing method is carried out until complete saccharification, i.e. iodine normal, are obtained.

The produced wort is then forwarded for particle removal (here in the lauter tun).

The mashing method according to the disclosure saves energy, reduces investment costs and operating costs of the plant, and is suited for many different recipes and types of rye, and it increases the raw material yield.

In the production of kvass, additives can also be employed apart from raw and basic materials.

As additives, diverse sweetening or acidifying ingredients as well as flavor-imparting ingredients, such as fruits and vegetables, and aromatic ingredients are added. Examples of them are: sugar and sugar products (caramel sugar, caramel, molasses, etc.), sweeteners (artificial, such as aspartame, or natural, such as honey), acids, artificial or natural citric or lactic acids, etc.), fruit and fruit products (pomaceous, stone and small fruits), nuts and nut products (strawberries), aromatic substances: mint, hop, onions, garlic, caraway, salt, pepper, chili, etc., natural and/or artificial flavors, such as vanillin, but also smoke flavor, bread flavor, burnt flavor. The flavors can be added into various process steps, for example before fermentation or after fermentation/filtration.

Example of the Production of Kvass

In the produced kvass, rye flour, barley, barley malt and fermented kvass rye malt are used as raw materials for the kvass-wort concentrate production. The following recipe was selected for this: 20% of fermented kvass malt, 15% of barley malt, 25% of barley, 40% of rye flour.

The fermented kvass malt and the barley malt were milled in a two-roll mill (distance of the rolls: 0.8 mm). The barley was milled by means of a hammer mill, and diverse technical enzyme preparations were used during mashing.

The pH value of the mash was adjusted by dosing technical lactic acid and NaOH. The mash liquor ratio was 1:3.

Mashing-in is done in a Shakesbeer mash tun with a Shakesbeer vibrator system of the Company Krones/Steinecker. In the introduction of the described raw materials, one tried to introduce as little oxygen as possible into the system. First, the cold brewing water was heated to 32° C., and the kvass malt was correspondingly mashed in with the rye flour (mash liquor ratio 1:2.8). After mashing-in, the pH value was adjusted to about 5.6, thermamyl and promozymes were added, and the mash was maintained at this temperature for about 15 minutes with the vibrator being switched on. Subsequently, the portion of rye mash was heated to 55° C., heating rate: 0.5° C. per minute, and a stand of about 10 minutes was kept. Then, the portion of rye mash was heated to 83° C. and maintained at this temperature for about 15 minutes. In the process, an iodine normality of the portion of mash already occurred. The second cold portion of mash was not produced in a separate mash tun but in the first mash tun. After the heat retention phase, the remaining amount of water was thus poured into the mash in a cold state, so that a mixing temperature of 56° C. was adjusted.

The vibrator was switched on again, and the remaining barley malt and the barley were added (at room temperature), so that the total mash had a temperature of about 54° C. Subsequently, the remaining enzymes described above were added, and the mashing temperature was maintained at 42° C. for 40 minutes. This was followed by a stand at 62° C. for 40 minutes and a stand at 42° C. for 35 minutes, before the iodine-normal mash was transferred into the pre-warmed mash filter for lautering at 83° C.

The proportion of the first portion of rye mash to the total mash was 65%. The amount of mash liquor of both portions of mash was 1:2.8.

Mash separation or lautering was done in a mash filter. In the process, a constant overpressure of 1 bar built up. The filtrate drained brightly with a first wort concentration of 23° Plato. After sparging, the pan full wort had a concentration of 18° Plato.

The produced kvass wort was boiled in this example.

Wort boiling was performed in a Stromboli-type boiling system of the Company Krones/Steinecker and lasted for 30 minutes. The boiling point was about 98° C.

The wort was clarified in a whirlpool. In the process, the wort is introduced into a cylindrical container tangentially, where a trub cone is formed in the center of the bottom of the whirlpool. Subsequently, a whirlpool stand is effected. This lasted about 10 minutes.

In this example, only one mash vessel was used. Of course, the above shown example can also be carried out using two mash devices or tuns 8a, b, respectively.

The parameters which have been shown in this example are merely given by way of example and can vary depending on the process.

The final wort obtained in this way can then be either first evaporated and then concentrated, treated further, or immediately forwarded to the fermentation process.

1. Mashing method for the production of kvass wort, comprising:
a) mashing in a first portion of mash, and heating the first portion of mash to a temperature below the boiling point,
b) mashing in a second portion of mash, and
c) heating the mixed first and second portions of mash in stages.

2. The mashing method according to claim 1, wherein one of in step a), the heating of the portion of mash is performed in a first mashing device, and the mashing-in of the second portion of mash in step b) is performed in a second mashing device, and the portions of mash are either mixed together in the first or in the second mashing device, or
in step a), the heating of the first portion of mash is performed in a first mashing device, and the second portion of mash is mashed in in the first mashing means.

3. The mashing method according to claim 1, wherein the temperature in step a) is within a range of from 75 to 90° C.

4. The mashing method according to claim 1, wherein, during heating of the first portion of mash, one of one stand and several stands within a temperature range of from 56° C. to 70° C. are kept.

5. The mashing method according to claim 1, wherein one of the mashing temperature of the second portion of mash is from 5 to 25° C., the mashing temperature of the first portion of mash is from 30 to 65° C., and a combination thereof.

6. The mashing method according to claim 1, wherein the first portion of mash is a portion of rye mash which comprises water and as raw material rye.

7. The mashing method according to claim 1, wherein the second portion of mash comprises water as well as at least one of the following raw materials or raw material products: barley, wheat, corn, buckwheat, rice and potatoes.

8. The mashing method according to claim 1, wherein the first portion of mash is a thick mash in which the mashing ratio of the amount of raw material (kg)/amount of water (l) is within a range of from 1:2 to 1:3.4, in particular 1:2.5 to 1:3.

9. The mashing method according to claim 1, wherein the first wort concentration is within a range of 18 to 28° P.

10. The mashing method according to claim 1, wherein the first portion of mash amounts to 40 to 80% of the total mash.

11. The mashing method according to claim 1, wherein at least in step c) of the mashing process, the mash is mechanically vibrated by means of a vibrator system.

12. Method of producing kvass with a mashing method according to claim 1, comprising:
providing raw materials,
mashing the raw materials mixed with water,
lautering/filtering the kvass wort from the mash, and
heating the kvass wort.

13. The method according to claim 12, wherein after fermentation of the kvass wort, one of:
filtering the kvass wort,
adding one of sugar, flavors, and a combination thereof, and
a combination thereof.

14. The method according to claim 12, wherein during heating, boiling the wort and separating off the hot break.

15. The method according to claim 12, wherein before fermentation, evaporating and concentrating the wort.

16. The method according to claim 15, and boiling the concentrate.

17. The masking method according to claim 1, wherein the first portion of mash is a portion of rye mash.

18. The mashing method according to claim 1, wherein the temperature below the boiling point is ≦90° C.

19. The mashing method according to claim 8, wherein the temperature in step a) is within a range from 80 to 85° C.

20. The mashing method according to claim 5, wherein the mashing temperature of the first portion of mash is from 35 to 55° C.

21. The mashing method according to claim 6, wherein the raw material rye comprises rye flow and fermented kvass rye malt.

22. The mashing method according to claim 8, wherein the mashing ratio is within a range of from 1:2.5 to 1:3.

23. The mashing method according to claim 9, wherein the first wort concentration is above 28° F.

24. The method of producing kvass according to claim 12, wherein the raw materials comprise milled malt and crushed raw materials.

25. The method according to claim 16, wherein the boiling is effected at overpressure with agitation.
